(19) United States
(12) Patent Application Publication
(10) Pub. No.: US 2025/0290372 A1
(43) Pub. Date: Sep. 18, 2025

(54) POCKET PROFILE FOR A VERTICALLY ADJUSTABLE INSTALLATION OF A RUNNER RAIL IN A DRY WALL CONSTRUCTION, MOUNTING ELEMENT FOR A VERTICALLY ADJUSTABLE INSTALLATION OF A RUNNER RAIL IN A POCKET DRYWALL CONSTRUCTION, AND DRYWALL CONSTRUCTION FOR A SLIDING DOOR SYSTEM

(71) Applicant: KNAUF GIPS KG, Iphofen (DE)

(72) Inventors: Marc HAGEDORN, Warstein (DE); Marc SCHÄFER, Becherbach (DE)

(21) Appl. No.: 18/861,271

(22) PCT Filed: Nov. 15, 2022
(86) PCT No.: PCT/EP2022/025509

§ 371 Date: Oct. 29, 2024

(30) Foreign Application Priority Data
May 9, 2022 (WO) PCT/EP2022/000043

(51) Int. Cl. E06B 3/46

(52) U.S. Cl. CPC E06B 3/4654

(57) ABSTRACT

A pocket profile for a vertically adjustable installation of a runner rail in a dry wall construction including at least one side flange portion with multiple male or female joint elements of a releasable fastening connection arranged therein, a related mounting element for a vertically adjustable installation of a runner rail in a pocket drywall and a related drywall construction system are disclosed.

The invention relates to a pocket profile for a vertically adjustable installation of a runner rail in a dry wall construction, a mounting element for a vertically adjustable installation of a runner rail in a pocket drywall construction, and a drywall construction for a sliding door system according to the respective independent claim.

Sliding door systems are often a preferred choice over wing doors as they provide an excellent finish and can be perfectly integrated into the drywalling system. Sliding door systems known in the state of the art comprise a pocket drywall construction with a runner rail arranged in between at least two pocket profiles configured to arrange a door leaf in such a way as to be moved at least partially in and out of the at least two pocket profiles. In order to account for different ceiling heights and door dimensions the vertical arrangement of the runner rail within the pocket drywall construction has always to be adjusted to the specific room.

This hinders a wider adoption of sliding door systems, as it makes their installation more complicated. The mounting components that are crucial for the assembly, such as different types of drywall profiles, which are assembled by different types of mounting elements, consume a lot of construction time and require an experienced professional for the construction. In case the necessary accuracy for the assembly has not been realized, a subsequent adjustment of the profiles and mounting elements, which are typically connected by screwing, can only be carried out with a time-consuming disassembly and reassembly.

The invention provides a solution to this problem by providing a pocket profile for a vertically adjustable installation of a runner rail in a dry wall construction, a mounting element for a vertically adjustable installation of a runner rail in a pocket profile, and a drywall construction for a sliding door system, which is specifically designed to be easily mounted and dismounted, and precisely adjusted in vertical height by implementing releasable fastening connections.

The invention relates to a pocket profile for a vertically adjustable installation of a runner rail in a dry wall construction comprising at least one side flange portion with multiple male or female joint elements of a releasable fastening connection arranged therein. The releasable fastening connection allows for an advantageous vertically adjustable installation by use of different male or female joint elements. The multiple male or female joint elements of a releasable fastening connection allow for a quick mounting of, e.g., mounting elements, a runner rail or traverse elements. The male or female joint elements can for example be configured to allow for a plug-in connection with complementary joint elements without the need for screwing connections.

According to a preferred aspect, the pocket profile comprises two side flange portions arranged in parallel at opposite sides of a base portion. Each side portion has multiple male or female joint elements.

The two side flange portions are arranged in parallel at opposite sides of a base portion in such a way as to be able to accommodate a door leaf in between them. The multiple male or female joint elements are arranged at the sides pointing in the same direction.

According to another preferred aspect, the male or female joint elements are configured as female joint elements having a side flap. The side flap can comprise a through hole with a rectangular opening.

The configuration as a side flap yields a simple embodiment of the female part of a plug-in connection for a releasable fastening connection of, e.g., mounting elements, a runner rail or traverse elements. The side flap can be configured as an outward bent portion of the respective flange portion or as a calotte portion.

According to a particularly preferred aspect, the male or female joint elements are arranged regularly spaced to each other within a range of 2 cm to 10 cm, and in particular within a range of 3 cm to 5 cm.

This provides a predefined and regularly spaced raster of arranged male or female joint elements which facilitates the assembly of the drywall construction and especially allows for a quick and easy vertically adjustable installation of a runner rail in predefined steps.

According to an advantageous aspect, each of the two side flange portions comprise one single row of male or female joint elements.

The single row can be located at one side portion of each of the two flange portions to allow easy access to the single row of male or female joint elements from one side.

The invention moreover relates to a mounting element for a vertically adjustable installation of a runner rail in a pocket drywall construction comprising a mounting plate and a mounting angle. Herein the mounting plate has a first raster profile and the mounting angle has a second raster profile formed complementary to the first raster profile. The second raster profile of the mounting angle can be interlocked at the first raster profile of the mounting plate in different positions to allow for the mounting angle to be adjustably fastened to the mounting plate.

The first raster profile and the second raster profile can be formed in such a way to allow for an adjustable fastening connection with predefined steps. These steps can be smaller than a vertical spacing of joint elements of a pocket profile of the pocket drywall construction. This allows for a fine adjustment in vertical position of a runner rail when mounted to the mounting element.

According to a preferred aspect, the mounting plate is configured as a U-shaped mounting bracket, wherein a first side element and a second side element of the U-shaped mounting bracket comprise at least one male or female joint element.

The at least one male or female joint element of the mounting plate can be configured complementary to a male or female joint element of a pocket profile of the pocket drywall construction in order to form a releasable fastening connection, e.g., a plug-in connection. The U-shaped mounting bracket can be configured in such a way as to be able to accommodate of a pocket profile of the pocket drywall construction in between the first side element and the second side element.

According to a particularly preferred aspect, the mounting plate has at least one guiding element, which is formed in such a way as to guide a sliding movement of the mounting angle along to the mounting plate.

The guiding element can be aligned in parallel with a direction of extension of the first raster profile and the second raster profile to guide a vertical movement of the first raster profile and the second raster profile relative to each other.

According to another preferred aspect, the mounting plate has two guiding elements that are configured as abutting edges aligned in parallel.

The abutting edges can be configured to be in contact with two side edges of the mounting angle when the mounting angle is mounted to the mounting plate.

According to an advantageous aspect, the mounting plate comprises height indication means capable of indicating the relative vertical position of the mounting angle with the mounting plate.

The height indication means can be configured as indicator lines or marks.

According to another advantageous aspect, the mounting angle comprises at least one slit designed to fit a screw for a vertically adjustable connection of the mounting angle to the mounting plate.

The slit can have a longitudinal extension in a range between 1 cm and 10 cm, in a range between 2 cm and 7 cm, in a direction parallel to a longitudinal extension of the first raster profile and the second raster profile in such a way, that if the screw is fit within the slit it guides a relative movement of the mounting angle and the mounting plate.

According to a particularly advantageous aspect, the mounting angle comprises at least one hole designed to fit a screw for additionally fixing the mounting angle to the mounting plate.

If the mounting angle comprises at least two holes they can be arranged in two parallel symmetric rows at the mounting angle in order to allow for a force-balanced fixing the mounting angle to the mounting plate.

According to a preferred aspect, the first raster profile and the second raster profile are formed as a triangular-shaped profile or as a wave-shaped profile or as a square-shaped profile.

Each of the profiles can be configured to have raster steps in a range in between 1 mm and 20 mm, and preferably in between 2 mm and 5 mm.

The invention moreover relates to a pocket drywall construction for a sliding door system comprising at least two pocket profiles according to the above description and at least two mounting elements for a vertically adjustable installation of a runner rail in between the at least two pocket profiles according to the above description.

By combining the at least two pocket profiles according to the above description and at least two mounting elements according to the above description one can achieve a precise vertical installation of a runner rail in the pocket drywall construction, where the multiple male or female joint elements of a releasable fastening connection of the pocket profiles allow for a coarse vertical adjustment and the first raster profile of the mounting plate and the second raster profile of the mounting angle allow for a fine vertical adjustment.

According to an advantageous aspect, the pocket drywall construction comprises at least one traverse element for a releasable fastening connection with the at least two pocket profiles, whereby the at least one traverse element has a first end section and a second end section, and whereby each of the first end section and second end section comprise at least one male or female joint element complementary to the male or female joint elements of the at least two pocket profiles for a releasable fastening connection with the at least two pocket profiles.

In this way the at least one traverse element provides enough stability to the pocket drywall construction by maintaining the benefits of a releasable fastening connection.

According to another advantageous aspect, the pocket drywall construction further comprises a runner rail arranged in between the at least two pocket profiles and releasably fastened with the at least two mounting elements to the at least two pocket profiles. The pocket drywall construction further comprises a door leaf arranged to the runner rail in such a way as to be moved at least partially in and out of the at least two pocket profiles.

For instance, the invention allows the runner rail to be precisely horizontally arranged within the pocket drywall construction.

In addition, the pocket profile for a vertically adjustable installation of a runner rail according to the invention also allows to arrange the runner rail in a defined, desired angle, i.e. to provide an intended inclination of the runner rail. Nevertheless, by using suitable suspension devices and/or trolleys, especially those having different length, the leaf of the sliding door can still be arranged vertically.

Preferably, the position of the door in the closed state lies lower than the position of the door in the open state. This means that due to the gravity, the door will automatically return the closed state from any open state. The angle of the inclination depends on the smoothness of the trolleys (wearing the door leaf) in the runner rail. Generally, an inclination up to 12 degrees to horizontal is sufficient for the intended effect. Preferably, the inclined runner rail is aligned in a range of 3 to 8 degrees to horizontal, for instance 5 degrees.

If desired, stoppers may be installed in the running rail or elsewhere at the pocket profile for holding the sliding door temporarily in the open position or in temporary positions. These stoppers may be realized such that they automatically release the door in case of respective triggers. For example, such a trigger can be a smoke and/or a heat detector that releases the door in case of a fire. This is especially useful for fire protection doors.

Accordingly, the mounting element according to the invention offers an easy access to self-closing sliding door.

The aforementioned self-closing sliding door is advantageous in any cases where it is desired of demanded that doors have to close automatically, e.g. in cases of fire protection doors, air gates, hospital doors or the like.

Of course, it is also possible to install self-opening sliding doors by aligning the runner rail in the inverted direction, i.e. such that the door leaf is lower in the open position.

In the following, the invention is described in connection to the drawings, where:

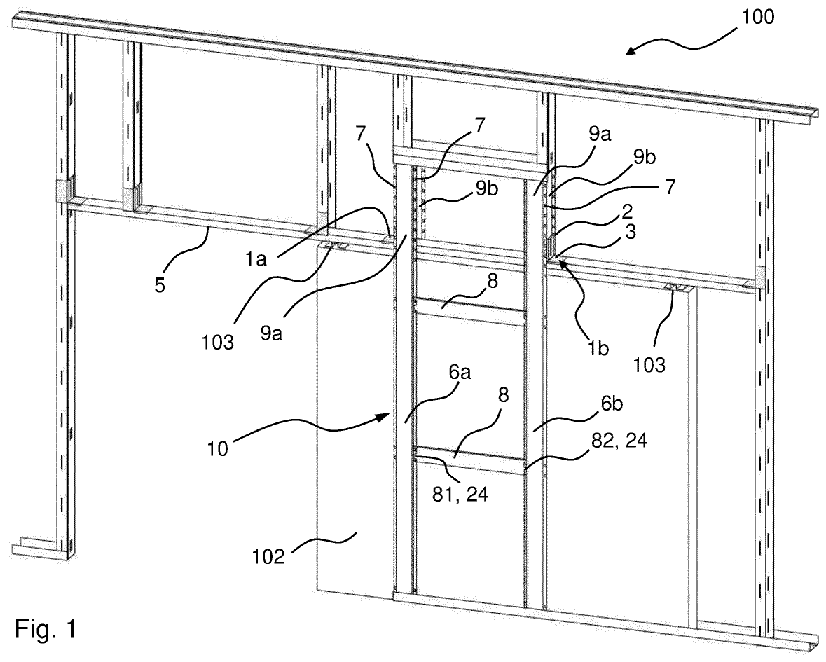

FIG. 1 is a schematic drawing of a sliding door system;

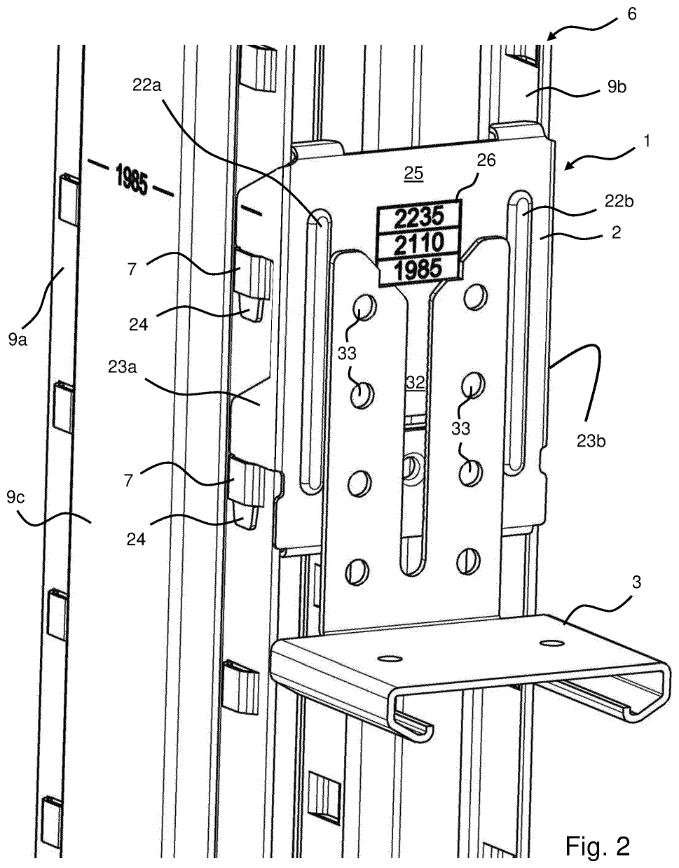

FIG. 2 is a schematic drawing of a mounting element which is releasably fastened to a pocket profile of the pocket drywall construction;

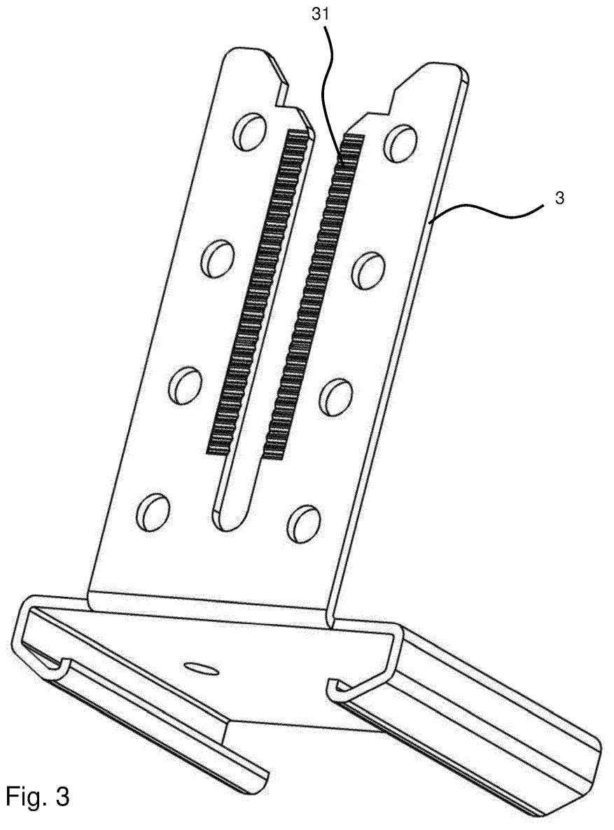

FIG. 3 is a schematic drawing of a mounting angle;

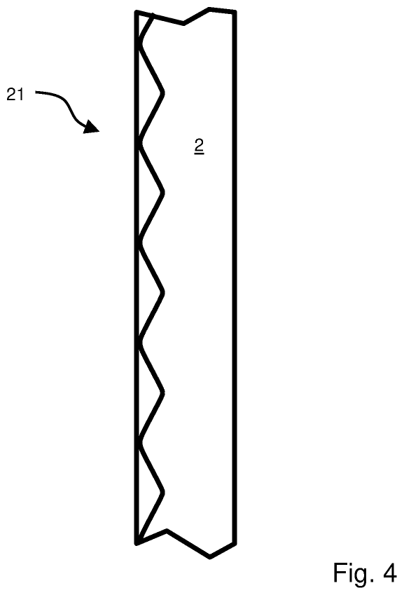

FIG. 4 is a cross-section through the first raster profile of the mounting plate; and

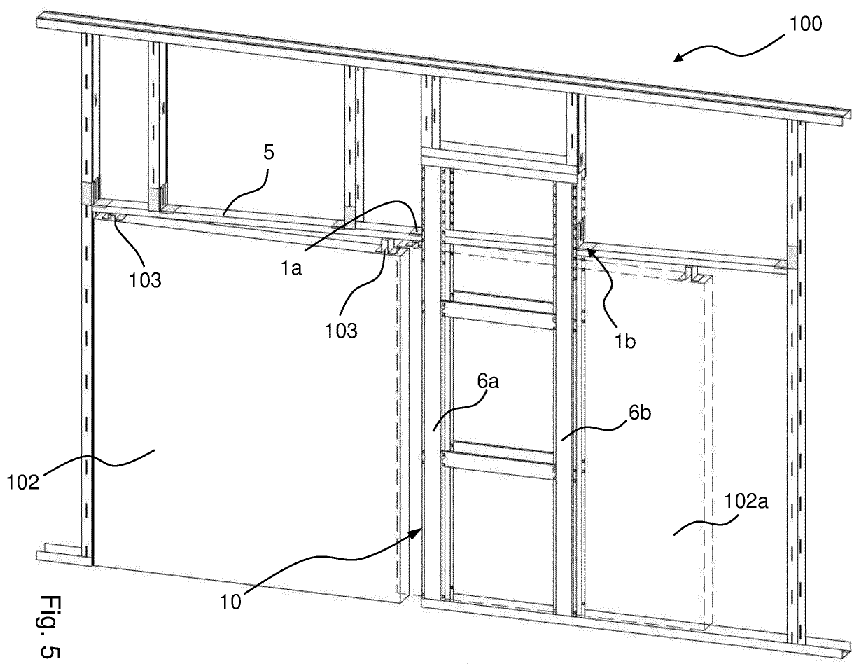

FIG. 5 is a schematic drawing of a self-closing sliding door.

FIG. 1 shows a schematic drawing of a sliding door system 100 comprising a pocket drywall construction 10. The pocket drywall construction 10 comprises two pocket profiles 6a, 6b and two mounting elements 1a, 1b for a vertically adjustable installation of the runner rail 5 in between the at least two pocket profiles 6a, 6b.

Each pocket profile 6 comprises two side flange portions 9a, 9b arranged in parallel at opposite sides of a base portion (not shown) in such a way as to be able to accommodate the door leaf 102 in between them. Each flange portion 9a, 9b has two rows comprising multiple female joint elements 7 of a releasable fastening connection that are configured as outward bent portions of the respective flange portion 9a, 9b (side flaps). The female joint elements 7 are arranged regularly spaced to each other by a distance of 3 cm.

This provides a predefined and regularly spaced raster of arranged female joint elements 7 which facilitates the assembly of the drywall construction and especially allows for a quick and easy vertically adjustable installation of a runner rail 5 in predefined steps. Being configured to allow for a plug-in connection, the female joint elements 7 allow for a quick mounting of, e.g., mounting elements 1, or traverse elements 8 in general.

The combination of the pocket profiles 6a, 6b and the mounting elements 1a, 1b allows to achieve a precise vertical installation of the runner rail 5 in the pocket drywall construction 10, because the multiple female joint elements 7 of the pocket profiles 6a, 6b allow for a coarse vertical adjustment and the first raster profile 21 (shown in FIG. 4) of the mounting plate 2 and the second raster profile 31 (shown in FIG. 3) of the mounting angle 3 allow for a fine vertical adjustment of the runner rail 5.

The pocket drywall construction 10 comprises two traverse elements 8 that are releasable fastened to the two pocket profiles 6a, 6b. Each traverse element 8 has a first end section 81 and a second end section 82, whereby each of the first end section 81 and second end section 82 comprise four male joint elements 24 complementary to male or female joint elements of the at least two pocket profiles 6a, 6b. In this way the traverse elements 8 provide enough stability to the pocket drywall construction 10 by maintaining the benefits of a releasable fastening connection.

The pocket drywall construction 10 further comprises a door leaf 102 arranged to the runner rail 5 in such a way-generally by using sliding suspension devices 103—as to be moved at least partially in and out of the at least two pocket profiles 6a, 6b.

FIG. 2 shows a schematic drawing of a mounting element 1 which is releasably fastened to a pocket profile 6 of the pocket drywall construction 10 (shown in FIG. 1).

The mounting element 1 comprises a mounting plate 2 and a mounting angle 3. Herein the mounting plate 2 has a first raster profile 21 (shown in FIG. 4) and the mounting angle 3 has a second raster profile 31 (shown in FIG. 3) formed complementary to the first raster profile 21 (shown in FIG. 4). The second raster profile 31 (shown in FIG. 3) of the mounting angle 3 can be interlocked at the first raster profile 21 (shown in FIG. 4) of the mounting plate 2 in different positions to allow for the mounting angle 3 to be adjustably fastened to the mounting plate 2.

The mounting plate 2 is configured as a U-shaped mounting bracket, wherein a first side element 23a and a second side element 23b of the U-shaped mounting bracket each comprise two male joint elements 24 which are configured complementary to female joint elements 7 of the pocket profile 6 in order to form a releasable fastening connection, and in this case a plug-in connection. The U-shaped mounting bracket is configured in such a way to accommodate the pocket profile 6 in between the first side element 23a and the second side element 23b.

The mounting plate 2 has two guiding elements 22a, 22b which are aligned in parallel, and which are formed in such a way as to guide a sliding movement of the mounting angle 3 along the mounting plate 2. The two guiding elements 22a, 22b are configured as parallel abutting edges that are in contact with two side edges of the mounting angle 3 when the mounting angle 3 is mounted to the mounting plate 2, as shown. The mounting plate 2 further comprises lines and marks as height indication means 26 that indicate the relative vertical position of the mounting angle 3 with the mounting plate 2.

The mounting angle 3 comprises one (half open) slit 32 designed to fit a screw for a vertically adjustable connection of the mounting angle 3 to the mounting plate 2.

The slit 32 can has a longitudinal extension of 7 cm, in a direction parallel to a longitudinal extension of the second raster profile 31 (shown in FIG. 3). If a screw is fit within the slit 32, it guides a relative movement of the mounting angle 3 and the mounting plate 2. The mounting angle 3 further comprises eight holes 33 each designed to fit a screw for additionally fixing the mounting angle 3 to the mounting plate 2. The holes 33 are arranged in two parallel symmetric rows at the mounting angle 3 in order to allow for a force-balanced fixing the mounting angle 3 to the mounting plate 2.

FIG. 3 shows a schematic drawing of the mounting angle 3 in FIGS. 1 and 2. The mounting angle 3 comprises a second raster profile 31 which is configured complementary to the first raster profile 21 (shown in FIG. 4) and to allow for an adjustable fastening connection with predefined steps. The raster steps are regularly spaced by 2 mm.

FIG. 4 shows cross-section through the first raster profile 21 of the mounting plate 2 in FIGS. 1 and 2. The first raster profile 21 is formed as a triangular-shaped profile.

FIG. 5 also shows a schematic drawing of a sliding door system 100, however, the runner rail 5 herein is installed inclined. The combination of the pocket profiles 6a, 6b and the mounting elements 1a, 1b allows to achieve an installation of the runner rail 5 in the pocket drywall construction 10 with a desired inclination angle. Herein, the door leaf 102 automatically will return from any open state 102a (dotted lines) into the close state (shown position of door leaf 102, solid lines) once it is released from any retention forces. Due to suspension devices 103 having different lengths and adapted to the inclination of the runner rail, the door leaf 102 is permanently aligned horizontally.

1. A pocket profile for a vertically adjustable installation of a runner rail in a dry wall construction comprising: at least one side flange portion with multiple male or female joint elements of a releasable fastening connection arranged therein.

2. The pocket profile according to claim 1, comprising two side flange portions arranged in parallel at opposite sides of a base portion.

3. The pocket profile according to claim 1, wherein the male or female joint elements are configured as female joint elements having a side flap.

4. The pocket profile according to claim 1, wherein the male or female joint elements are arranged regularly spaced to each other within a range of 2 cm to 10 cm.

5. The pocket profile according to claim 1, wherein each of the two side flange portions comprise one single row of male or female joint elements.

6. A mounting element for a vertically adjustable installation of a runner rail in a pocket drywall construction comprising: a mounting plate and a mounting angle; wherein the mounting plate has a first raster profile and the mounting angle has a second raster profile formed complementary to the first raster profile; and wherein the second raster profile of the mounting angle can be interlocked at the first raster profile of the mounting plate in different positions to allow for the mounting angle to be adjustably fastened to the mounting plate.

7. The mounting element according to claim 6, wherein the mounting plate is configured as a U-shaped mounting bracket, wherein a first side element and a second side element of the U-shaped mounting bracket comprise at least one male or female joint element.

8. The mounting element according to claim 6, wherein the mounting plate has at least one guiding element, which is formed in such a way as to guide a sliding movement of the mounting angle along to the mounting plate.

9. The mounting element according to claim 8, wherein the mounting plate has two guiding elements that are configured as abutting edges aligned in parallel.

10. The mounting element according to claim 6, wherein the mounting plate comprises height indication means capable of indicating the relative vertical position of the mounting angle with the mounting plate.

11. The mounting element according to claim 6, wherein the mounting angle comprises at least one slit designed to fit a screw for a vertically adjustable connection of the mounting angle to the mounting plate.

12. The mounting element according to claim 6, wherein the mounting angle comprises at least one hole designed to fit a screw for additionally fixing the mounting angle to the mounting plate.

13. The mounting element according to claim 6, wherein the first raster profile and the second raster profile are formed as a triangular-shaped profile or as a wave-shaped profile or as a square-shaped profile.

14. A pocket drywall construction for a sliding door system comprising at least two pocket profiles, wherein each said profile has at least one side flange portion with multiple male or female joint elements of a releasable fastening connection arranged therein, and at least two mounting elements for a vertically adjustable installation of a runner rail in between the at least two pocket profiles according to claim 6.

15. The pocket drywall construction according to claim 14, comprising at least one traverse element for a releasable fastening connection with the at least two pocket profiles, whereby the at least one traverse element has a first end section and a second end section, whereby each of the first end section and second end section comprise at least one male or female joint element complementary to the male or female joint elements of the at least two pocket profiles for a releasable fastening connection with the at least two pocket profiles.

16. The pocket drywall construction according to claim 14, further comprising a runner rail arranged in between the at least two pocket profiles and releasably fastened with the at least two mounting elements to the at least two pocket profiles, further comprising a door leaf arranged to the runner rail in such a way as to be moved at least partially in and out of the at least two pocket profiles.
